(19) United States
(12) Patent Application Publication
(10) Pub. No.: US 2026/0147995 A1
(43) Pub. Date: May 28, 2026

(54) Automated Data Extraction Using Large Language Model

(71) Applicant: PayPal, Inc., San Jose, CA (US)

(72) Inventors: Suraj Arulmozhi, Chennai (IN); Hagar Oppenheim, Santa Clara, CA (US); Trishul Soni, Milpitas, CA (US); Sina Modaresi, San Jose, CA (US); Kunal Verma, Noida (IN); Senthil Sugesh Palanisamy, Chennai (IN); Aditya Shukla, South West Delhi (IN); Gal Hochma, Ramat Gan (IL); Mor Rozenker, Ramat Gan (IL); Zohar Li Marad, Tel Aviv (IL); Ruobai Wang, Shanghai (CN); Yirou Ge, Shanghai (CN); Ashok Subash, Chennai (IN); Vidya Latha Pyla, Chennai (IN); Sathya Rajaram, Chennai (IN)

(21) Appl. No.: 19/042,564

(22) Filed: Jan. 31, 2025

(30) Foreign Application Priority Data
Nov. 28, 2024 (WO) PCT/CN2024/135120

(51) Int. Cl. G06F 40/216; G06F 16/25

(52) U.S. Cl. CPC G06F 40/216; G06F 16/252

(57) ABSTRACT

Techniques are disclosed relating to extracting data from a document, using a large language model (LLM), to populate fields in a data structure. A computer system may receive a request to populate multiple fields of a data structure with data extracted from text of a document. The computer system parses the text using an LLM (as well as regular expressions or other parsing techniques in some embodiments). The parsing includes issuing, to the LLM, a sequence of queries targeting individual ones of the multiple fields. The computer system applies a validation algorithm to results received from the LLM in response to the sequence of queries. The validation algorithm confirms the presence of results in the text of the document and populates the data structured with the validated results. In various embodiments, the computer system performs an optical character recognition (OCR) on the document to determine the text for parsing.

### PRIORITY CLAIM

The present application claims priority to PCT Appl. No. PCT/CN2024/135120, entitled “AUTOMATED DATA EXTRACTION USING LARGE LANGUAGE MODEL”, filed Nov. 28, 2024, which is incorporated by reference herein in its entirety.

### BACKGROUND

### Technical Field

This disclosure relates generally to computer systems and, more specifically, to various mechanisms for extracting data from a document to populate fields in a data structure.

### Description of the Related Art

Enterprises are increasingly utilizing machine learning to enhance the services that they provide to their users. Using machine learning techniques, a computer system can perform natural language processing tasks. For example, a large language model (LLM) is a generative model that is designed to understand natural human language and output a relevant response. Examples of LLMs can include generative pre-trained transformers (GPTs) and text-to-text transfer transformers (T5). As part of the training process, an LLM is provided with large datasets of text such that it can learn complex relationships between words and concepts. As a result, LLMs can be used in a variety of applications, such as real-time assistance, answering queries, content creation, and summarizing documents.

### BRIEF DESCRIPTION OF THE DRAWINGS

FIG. 1 is a block diagram of one embodiment of a system that is capable of extracting data from a document, using an LLM, to populate a data structure.

FIG. 2 is a block diagram of one embodiment of a parsing module that is capable of parsing data from a document based on an LLM and regular expressions.

FIG. 3 is a block diagram of one embodiment of a validation module that is capable of validating the outputs of the parsing module based on one or more validation techniques.

FIG. 4 is a block diagram of one embodiment of a data structure schema that defines fields of the populated data structure.

FIGS. 5A-C are flow diagrams illustrating embodiments of methods implementing techniques described herein.

FIG. 6 is a block diagram illustrating elements of an exemplary computer system for implementing techniques described herein.

### DETAILED DESCRIPTION

In many cases, an enterprise can possess large numbers of documents, which it wants to ingest into a computing system in format that can be acted upon by the computing system. Examples of documents may include contracts, records, technical manuals, client information, handwritten notes, forms, etc., which may each include varying sets of information. In order to ensure this information is ingested accurately, an individual typically manually reviews and enters key information. For example, in the case of a contract, a contract manager may record information such as identity information of the client, contract start and end dates, deliverables, pricing and fees, amendments, performance metrics, etc. Manually tracking data for thousands of documents can be prone to human error, which can lead to non-compliance, legal disputes, and financial penalties. Additionally, the process is time-consuming and inefficient, particularly when managing large volumes of documents across different departments or regions.

The present disclosure describes embodiments in which a computing system is used to extract data from a document, based on an LLM, to populate fields in a data structure. As will be described below in various embodiments, the system may receive a request to populate multiple fields of a data structure with data extracted from text of a document. For example, the system may receive a request to extract information from an application in order to populate a table associated with employee information. As part of extracting data from the document, the computer system parses the text using a large language model (LLM). This may include issuing, to the LLM, a sequence of queries targeting individual ones of the multiple fields. The computer system applies a validation algorithm to results received from the LLM in response to the sequence of queries. The validation algorithm may confirm the presence of these results in the text of the document. After validating the results, the computer system populates the data structured with the validated results.

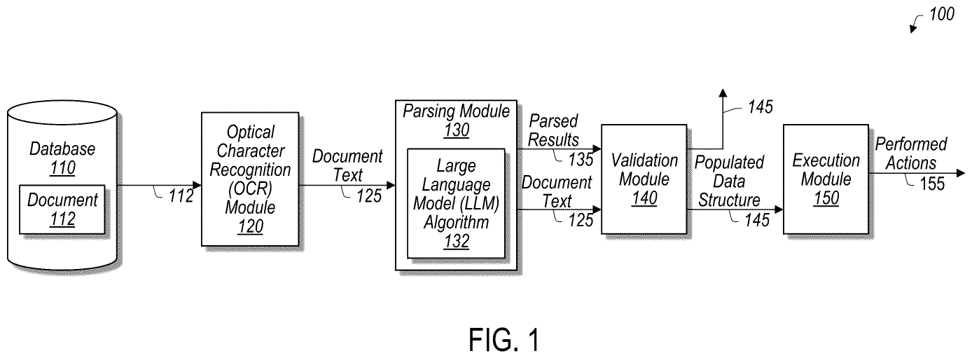

These techniques may be advantageous over prior approaches as these techniques allow for a system to extract data from a document, using an LLM, to populate fields in a data structure. By implementing this system, an LLM can quickly search through large volumes of data in a document to identify and extract key information. Furthermore, an LLM can process a document with a high degree of contextual understanding, allowing it to extract accurate information. As a result, this significantly reduces manual effort and subsequent human error. An exemplary application of these techniques will now be discussed, starting with reference to FIG. 1.

Turning now to FIG. 1, a block diagram of system 100 is shown. System 100 includes a set of components that may be implemented via software, hardware, or a combination thereof. In the illustrated embodiment, system 100 includes a database 110, optical character recognition (OCR) module 120, a parsing module 130, a validation module 140, and an execution module 150. As further depicted, database 110 includes documents 112. Parsing module 130 includes a large language model (LLM) algorithm 132. In some embodiments, system 100 is implemented differently than shown. For example, LLM algorithm 132 may be implemented separately from parsing module 130, parsing module 130 may receive document text 125 directly from database 110 (without undergoing OCR), etc.

System 100, in various embodiments, is a system that populates fields of a data structure with data extracted from documents 112 using a large language model (LLM). In some embodiments, system 100 is part of a platform that provides one or more services (e.g., a cloud computing service, a customer relationship management service, and a payment processing service) that are accessible to users that can invoke functionality of the services to achieve a user-desired objective. To facilitate the functionality of those services, system 100 may execute various software routines, such as parsing module 130, as well as provide code, web pages, and other data to users, databases, and other entities that use system 100. In various embodiments, system 100 is implemented using a cloud infrastructure that is provided by a cloud provider. Components of system 100 may thus execute on and use cloud resources of that cloud infrastructure (e.g., computing resources, storage resources, etc.) to facilitate their operation. For example, software that is executable to implement validation module 140 may be stored on a non-transitory computer-readable medium of server-based hardware included in a datacenter of the cloud provider. That software may be executed in a virtual environment that is hosted on the server-based hardware. In some embodiments, system 100 is implemented using a local or private infrastructure as opposed to a public cloud. As shown in the illustrated embodiment, system 100 includes database 110.

Database 110, in various embodiments, is a collection of information that is organized in a manner that allows for access, storage, and/or manipulation of that information. For example, database 110 may be a cloud database that is deployed and accessed via a cloud computing platform (e.g., Amazon S3®). As shown in the illustrated embodiment, database 110 stores document 112. Documents 112, in various embodiments, can stored in any suitable format such as an image file (e.g., .png), a portable document format (PDF) file, a text-based file (.txt), a web page (.html), etc. that contains handwritten, printed, and/or typed text. Document 112 may be a contract, a handwritten note, a form, an application, a receipt, a certificate, a business card, a technical manual, a medical record, construction blueprints, illustrations with text, business plans, etc. For example, document 112 may be a contract that is represented as a digital image and includes printed and/or handwritten text in the image. As shown in the illustrated embodiment, database 110 provides document 112 to optical character recognition (OCR) module 120.

OCR module 120, in various embodiments, is software that is executable to convert images of handwritten, printed, and/or typed text in document 112 into machine-readable text. OCR module 120 may perform one or more preprocessing operations to prepare the document for analysis. These preprocessing operations may include binarization, noise removal, deskewing, despeckling, image scaling, thinning and skeletonization, zoning, etc. For example, OCR module 120 may use binarization to convert a document, such as a PDF including text, images, and tables, into a binary image that includes two colors (e.g., black and white). As a result, binarization may improve OCR module's 120 ability to identify letters and/or numerical values.

OCR module 120, in various embodiments, uses one or more algorithms to process document 112 and convert it into machine-readable text. These algorithms may include pattern-recognition algorithms and/or feature detection algorithms. A pattern-recognition algorithm classifies a character in document 112 by comparing it to a predefined set of characters, digits, symbols, etc. For example, a pattern-recognition algorithm may compare a printed letter in document 112 to a set of letter templates in order to calculate a set of similarity scores. The pattern-recognition algorithm may determine to classify the handwritten letter based on the highest similarity score. A feature extraction algorithm extracts and analyzes feature(s) associated with a character in document 112 in order to classify it. These features may describe the position (e.g., vertical), length, width, junction, curve, start point, end point, etc. of one or more lines that constitutes the character. For example, a feature extraction algorithm may classify a character as an “S” based on the position of its start and end point, lack of intersecting lines, and shape of its curves. In various embodiments, the feature extraction algorithm is a machine learning model (e.g., convolutional neural network) that is trained based on labeled datasets of characters in order to classify characters of document 112.

OCR module 120, in various embodiments, is configured to detect table structures in document 112 in order to extract tabular data from those tables. For example, OCR module 120 may detect grid structures that are indicative of tables based on horizontal lines, vertical lines, line spacing, text alignment, text spacing, etc. In response to detecting one or more tables in document 112, OCR module 120 may extract and output the tabular data in a structured format that is ingestible by parsing module 130. For example, OCR module 120 may output data from a table as a CSV file such that LLM 220 can process and identify headers, rows, columns, and records.

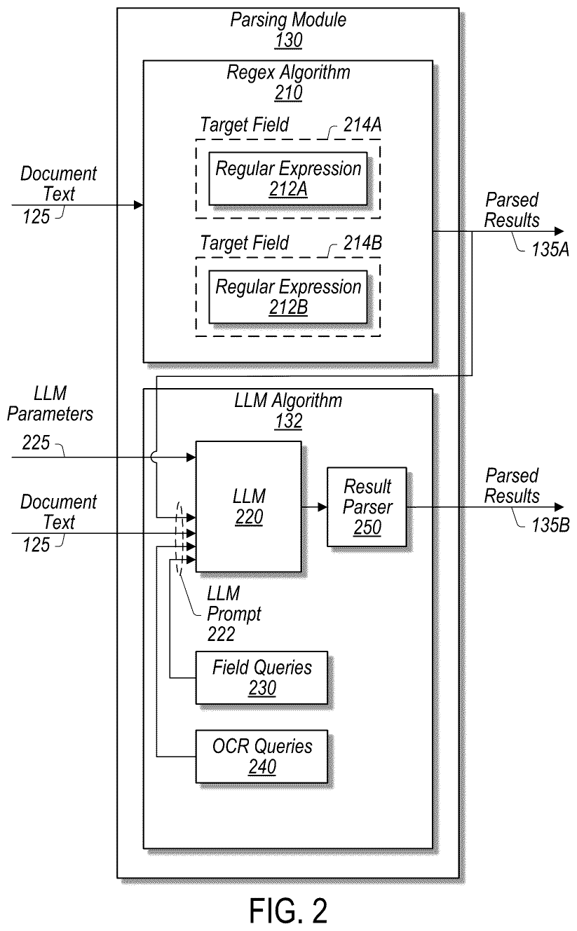

After the character recognition process, OCR module 120, in various embodiments, performs one or more post-processing operations to detect and correct errors. These post-processing operations may include spell checks, word corrections, layout and formatting restoration, confidence scoring, etc. For example, OCR module 120 may calculate a confidence score that represents the probability that a particular word is correct. If the confidence score does not satisfy a threshold, OCR module 120 may output an error. In various embodiments, OCR module 120 uses a machine learning model (e.g., LLM 220) to detect and correct errors in document text 125. This is discussed in greater detail with respect to FIG. 2. In the illustrated embodiment, OCR module 120 outputs document text 125 and provides it to parsing module 130.

Parsing module 130, in various embodiments, is executable software that parses data from document text 125 using techniques, such as LLM algorithm 132, to output parsed results 135. For example, parsing module 130 may parse a value associated with a customer ID based on a regular expression. LLM algorithm 132, in various embodiments, parses information from document text 125, using an LLM, based on a set of queries that target fields described by a schema. For example, LLM algorithm 132 may process a query associated with a “date” field, and based on the context of document text 125, LLM algorithm 132 may output a date to populate the “date” field. Parsing module 130 and LLM algorithm 132 are discussed in greater detail with respect to FIG. 2. Parsing module 130 provides parsed results 135 and document text 125 to validation module 140.

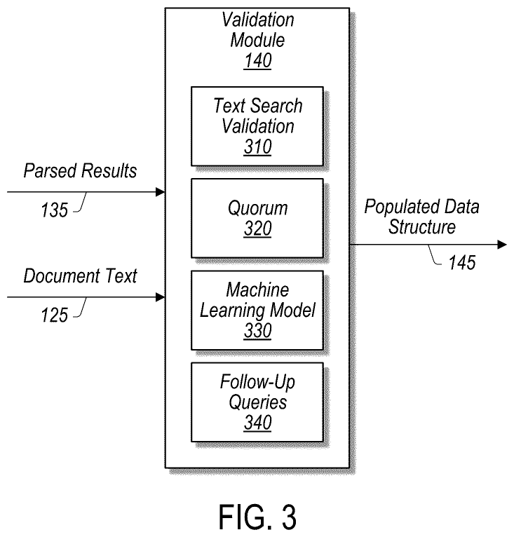

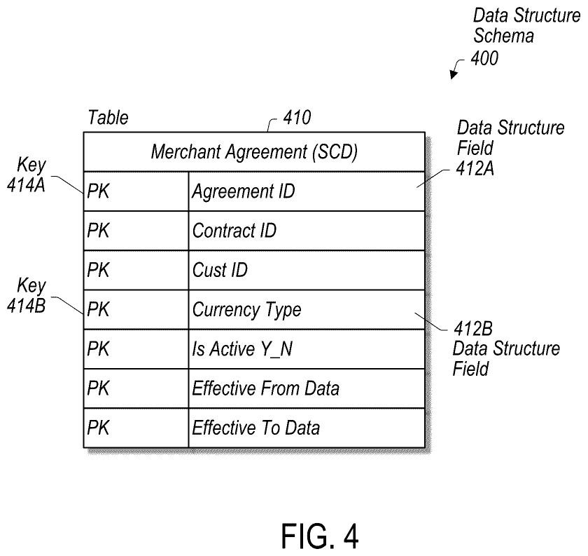

Validation module 140, in various embodiments, is executable software that applies one or more validation algorithms to parsed results 135 in order to confirm their presence in document text 125. For example, validation module 140 may perform a word search to determine whether a particular parsed result 135 is in document text 125. Validation module 140 is discussed in greater detail with respect to FIG. 3. After validating one or more parsed results 135, validation module 140 provides a populated data structure 145 to execution module 150. Populated data structure 145, in various embodiments, is a set of parsed results 135 that is organized in a structured format according to a data structure schema. Data structure schema is discussed in greater detail with respect to FIG. 4.

Execution module 150, in various embodiments, is executable software that performs actions 155 (or causes performance of actions 155 by issuing instructions to other components of system 100) based on populated data structure 145. Actions 155 may include storing populated data structure 145 in a database, displaying the populated data structure 145 via a user interface (UI), causing parsing module 130 to reevaluate document text 125, causing a computer system to implement a service associated with document 112 based on the populated data structure 145, etc. For example, execution module 150 may cause reevaluation of document text 125 in response to receiving a populated data structure 145 with invalid fields and/or missing values in those fields. In some embodiments, system 100 is used to validate information stored in an existing data structure about a given document 112. For example, this information may have been entered previously by an individual who was manually reviewing a given document and recording its information. Accordingly, system 100 may receive a request to validate multiple populated fields in this existing data structure with data extracted from text of the given document 112. System 100 may then retrieve the document 112 (or document text 125) from database 110 and provide the text to modules 130 and 140. The validated results from module 140 may then be compared against the multiple populated fields in the existing data structure being validated. In response to the results matching data in each of the fields, execution module 150 may perform one or more actions 155 such as storing an indication with the data structure that its data has been validated by system 100, issuing an instruction to a user interface to notify a user that the existing data structure includes valid data, etc. In response to the comparing including a mismatch, execution module 150 may perform one or more actions 155 such as altering data in one or more of the populated fields in the existing data structure, notifying a user of the mismatch, triggering a need to take a corrective action associated with the document such as enlisting a user to confirm which one of the mismatching fields is the correct field, etc.

Turning now to FIG. 2, a block diagram of an example parsing module 130 is shown. In the illustrated embodiment, parsing module 130 includes a regex algorithm 210 and LLM algorithm 132. As further depicted, regular expression (regex) algorithm 210 includes regular expression 212A and regular expression 212B. LLM algorithm 132 includes LLM 220, field queries 230, OCR queries 240, and result parser 250. In some embodiments, parsing module 130 is implemented differently than shown. For example, parsing module 130 may include a fewer or greater number of regular expressions and/or machine learning models.

Regex algorithm 210, in various embodiments, applies one or more regular expressions 212 to document text 125 in order to generate parsed results 135A. Regular expression 212 is a sequence of characters that defines a search pattern for identifying strings in document text 125 that conform to a particular formant. For example, regular expression 212A may define a pattern for identifying strings that conform to a date format (e.g., MM/DD/YYYY). Accordingly, regex algorithm 210 may apply regex expression 212A to search for dates within document text 125. In some embodiments, regular expressions 212 are tailored to parse information based on one or more target fields 214. Target field 214, in various embodiments, is a data field in a record of a table that conforms to a data structure schema. For example, target field 214 may be defined as a “charge rate” field, and accordingly, regular expression 212 may be tailored to identify numerical values that precede a percentage sign. In some embodiments, parsed results 135A may be provided as an input to LLM algorithm 132 as shown. That is, regex algorithm 210 may make an initial pass at document text 125 to extract parsed results 135A, which may be sufficient to identity all pertinent results for simpler documents 112. For more complex documents 112, results 135A may be provided to LLM algorithm 132 to expand the information available to LLM algorithm to produce parsed results 135B.

LLM algorithm 132, in various embodiments, is software that is executable to parse information from document text 125, using LLM 220, based on a set of queries (e.g., field queries 230). LLM 220, in various embodiments, uses one or more neural networks (e.g., transformer) to process a query and output a response based on its context and the context of document text 125. As shown, LLM 220 receives document text 125 from OCR module 120. In some embodiments, a preprocessing module prepares the textual description from document text 125, using preprocessing techniques such as tokenization, to produce an input suitable for processing by LLM 220. Tokenization breaks the textual description into smaller units called tokens. For example, the preprocessing module may separate the textual description from document text 125 into individual words. After the text in document text 125 is tokenized, the preprocessing module converts the tokens into initial embeddings to feed into LLM 220.

In various embodiments, the preprocessing module adds positional encodings to the initial embeddings. The preprocessing module encodes, for an embedding, positional information describing that embedding's position within a sequence of embeddings based on its position within a sentence from document text 125. As an example, the unique positional encoding associated with a particular embedding may indicate that the particular word is the fourth word in a sentence. The positional encoding allows LLM 220 to distinguish the ordering of embeddings in a sequence of embeddings when using parallel computation.

In various embodiments, positional encoding allows LLM 220 to identify a value associated with a sequence of words. For example, the phrase “customer ID” may precede a sequence of numbers in document text 125. This may be reflected in the positional encodings of “customer ID” and the sequence of numbers as the positional encoding of the sequence of numbers encodes a position that is after the position encoded in the positional encoding of “customer ID.” The preprocessing module, in various embodiments, encodes positional information that describes the position of a character(s) in a table of document text 125. For example, document text 125 may include a user table that consists of columns and rows associated with user IDs, phone numbers, and email addresses. The positional encoding of a particular value in the user table may indicate that the particular value is in the “email address” column and is in a row associated with a particular user ID. After producing a positional aware embedding, the preprocessing module provides these embeddings to LLM 220.

To facilitate the parsing of document text 125 to produce parsed results 135B, LLM 220 receives field queries 230 and/or OCR queries 240. Queries 230 and 240 may include one or more questions, commands, and/or statements that are text-based and copackaged with document text 125 (or parsed results 135A) in an LLM prompt 222 submitted to LLM 220. OCR query 240, in various embodiments, is a prompt targeted to evaluate document text 125 in order to identify OCR errors. Types of OCR errors may include misrecognized characters, missing characters, additional characters, incorrect word substitution, etc. For example, OCR module 120 may misidentify a sequence of characters as “contact ID” instead of “contract ID” in document text 125. In response to receiving OCR query 240, LLM 220 may determine that “contact ID” is incorrect based on the context of surrounding words in document text 125. In various embodiments, LLM 220 retains context, in its context window, that describes identified OCR errors such that LLM 220 considers these errors when generating outputs. For example, LLM 220 may receive a query to identify a value associated with “contract ID” in document text 125. LLM 220 may process the query and identified OCR errors to determine to provide the value associated with “contact ID” in document text 125. In various embodiments, LLM 220 may provide the identified OCR errors with parsed results 135 to validation module 140. For example, validation module 140 may consider OCR errors identified by LLM 220 when validating parsed results 135.

Field query 230, in various embodiments, is a prompt to LLM 220 targeted to identify data in document text 125. For example, field query 230 may instruct LLM 220 to identify a contract identification number within a contract. As a result, LLM 220 processes the text of the contract and outputs a response with information associated with the contract identification number. In various embodiments, field query 230 is a prompt to identify data associated with one or more target fields 214. For example, field query 230 may instruct LLM 220 to populate a target field 214 associated with “currency type.” As a result, LLM 220 may process document text 125 to identify the type of currency described by text 125 and populate target field 214 with its output.

LLM parameters 225, in various embodiments, are configuration parameters that influence how LLM 220 processes document text 125 and generates an output. Types of LLM parameters 225 may include temperature, number of tokens, top-p, top-k, random seed, repetition penalty, etc. Temperature is a parameter (e.g., numerical value) that determines the randomness of the output generated by LLM 220. For example, a lower temperature value reduces randomness and causes LLM 220 to generate more deterministic outputs and reduce the likelihood of hallucinations. Number of tokens is a parameter that defines the maximum number of tokens that LLM 220 is allowed to use when generating an output. For example, a lower maximum number of tokens causes LLM 220 to generate shorter outputs.

Top-p is a parameter that determines the set of tokens that can be selected for the output of LLM 220 by defining the threshold for the cumulative probability of all tokens in the set. The top-p parameter causes LLM 220 to select from the smallest set of tokens whose cumulative probability is equal to or greater than the threshold. For example, a lower top-p parameter may cause LLM 220 to select a word from a smaller set of words with the highest probabilities. As a result, a lower top-p parameter causes LLM 220 to generate outputs that are less diverse.

Top-k is a parameter that determines the sampling size of tokens that can be selected for the output of LLM 220. A smaller value for top-k causes LLM 220 to generate more deterministic outputs. For example, the value for top-k may be set to five, and as a result, LLM 220 only considers a set of five tokens with the highest probability. Random seed is a numerical value associated with an output of LLM 220 such that LLM 220 generates the same output in response to receiving the same input. For example, LLM 220 may generate a textual output in response to receiving a particular field query 230. When given the same field query 230 and seed value, LLM 220 generates the same textual output. Repetition penalty is a parameter that adjusts the probability score of a token based on its repeated use. For example, repetition penalty may decrease the probability score of a token such that the likelihood of it being selected by the LLM 200 is lowered. A higher value for repetition penalty causes LLM 220 to generate outputs that do not include repeated text.

Result parser 250, in various embodiments, parses the textual outputs of LLM 220 to generate parsed results 135. For example, LLM 220 may output a sentence that includes a value in response to receiving field query 230. To facilitate the population of a target field 215, result parser 250 may parse the value from the sentence and output parsed result 135. Parsed results 135 are provided to validation module 140. Validation module 140 is discussed in greater detail with respect to FIG. 3.

Turning now to FIG. 3, a block diagram of an example validation module 140 is shown. In the illustrated embodiment, validation module 140 includes text search validation 310, quorum 320, machine learning model 330, and follow-up queries 340. In some embodiments, validation module 140 is implemented differently than shown. For example, validation module 140 may include a fewer or greater number of verification techniques.

Validation module 140, in various embodiments, uses one or more validation techniques to verify the accuracy of parsed results 135. Validation techniques include text search validation 310, quorum 320, machine learning model 330, and follow-up queries 340. Text search validation 310, in various embodiments, includes one or more algorithms for comparing the parsed results 135 of parsing module 130 to the data described in document text 125 based on a character (e.g., word) search. For example, LLM algorithm 132 may process document text 125 and field query 230 to output a numerical value associated with a fee percentage. Validation module 140 may compare this numerical value to values in document text 125 to determine whether it is present within document text 125. Validation module 140 may repeat this process until each parsed result 135 is verified.

Quorum 320, in various embodiments, includes one or more algorithms for comparing the parsed results 135 of LLM algorithm 132 to the parsed results 135 of regex algorithm 210 (or other parsing algorithms used by parsing module 130). For example, LLM algorithm 132 and regex algorithm 210 may separately analyze document text 125 to identify a contract effective date. Validation module 140 may compare the parsed results 135 from algorithm 210 to the parsed result 135 from algorithm 132 to determine if the outputs match. In various embodiments, quorum 320 compares the parsed results 135 of LLM 220 to the parsed results 135 from one or more, separate machine learning models. For example, document text 125 and field query 230 may be provided to LLM 220, such as ChatGPT, and a second LLM, such as BERT. Validation module 140 may compare the output of ChatGPT to the output of BERT to determine if the outputs convey similar information. Quorum 320 may repeat this process until each parsed result 135 is verified.

Machine learning model 330, in various embodiments, uses one or more neural networks to analyze the performance of LLM 220 by comparing its outputs to information described in document text 125. For example, LLM 220 may analyze a technical manual to identify a model number associated with a product described in the technical manual. Machine learning model 330 may receive a prompt that causes model 330 to analyze the technical manual in order to verify the presence of the model number. In various embodiments, machine learning model 330 is a scored-based algorithm that calculates a score (e.g., probability) which represents the level of abnormality for a parsed result 135 in a particular target field 214. For example, a target field 214 associated with a “merchant fee” may be expected to have a value within the range of 2-5%. Because of an unidentified OCR error in document text 125, LLM 220 may output a value of 25% for the “merchant fee” target field 214 which is outside the expected range. Model 330 may detect that the value is outside the expected range, and accordingly produce a score indicative of how abnormal the value is, where its abnormality may be based on how far it deviates from the range.

Follow-up query 340, in various embodiments, is a prompt to LLM 220 to verify the presence of one or more parsed results 135 in document text 125. For example, LLM 220 may output a response that identifies a value associated with a customer ID based on field query 230. In response to receiving follow-up query 340, LLM 220 may analyze document text 125 to determine if the identified value is present in document text 125. In various embodiments, follow-up query 340 is a set of queries that are provided to LLM 220 to facilitate the output of a second set of parsed results 135. Follow-up queries 340 may include similar verbiage as field queries 230 and/or OCR queries 240. For example, field query 230 may instruct LLM 220 to identify data in a “customer ID” column of a table. Field query 230 may be rephrased as a follow-up query 340 and provided to LLM 220 to identify data in the same column. Validation module 140 may compare the parsed result 135 based on field query 230 to the parsed result 135 based on follow-up query 340 in order to determine if they match.

In response to determining that a parsed result 135 is not valid, validation module 140 may send an indication to execution module 150. Based on this indication, execution module 150 may perform one or more actions 155 that cause parsing module 130 to reevaluate document text 125 in order to generate a new parsed result 135 for a previously invalid target field 214. For example, validation module 140 may send a notification to execution module 150 that describes invalid data associated with a target field 214 labeled “address.” As a result, execution module 150 may cause LLM 220 to receive a particular field query 230 associated with “address” field 214 such that LLM 220 generates a new parsed result 135. In various embodiments, validation module 130 generates and sends a notification to a user via a user interface (UI). In response to verifying the accuracy of parsed results 135, validation module 140 outputs populated data structure 145.

Turning now to FIG. 4, a block diagram of an example data structure schema 400 is shown. In the illustrated embodiment, data structure schema 400 includes table 410 with data structure fields 412A and 412B. In some embodiments, data structure schema 400 is implemented differently than shown. For example, data structure schema 400 may include a fewer or greater number of data structure fields 412.

LLM algorithm 132 and/or regex algorithm 210 output parsed results 135 in order to populate data structure fields 412 in table 410 according to data structure schema 400. Data structure schema 400, in various embodiments, includes key-value pairs that define the structure, data structure fields 412, data types (e.g., strings, numbers, arrays, etc.), constraints, metadata (e.g., title, description), etc. of table 410. For example, schema 400 may define the description of data structure field 412A as “agreement ID” and the data type of field 412A as number.

Data structure schema 400 may be used to validate parsed results 135 from LLM algorithm 132 and/or regex algorithm 210. For example, LLM algorithm 132 may output a string (e.g., word) for the “agreement ID” data field 412A. Because the data type of field 412A is defined as a number according to schema 400, the output of algorithm 132 is not validated. In response to determining parsed result(s) 135 in table 410 are invalid, a validation error is generated and provided to validation module 140. As a result, validation module 140 may cause parsing module 130 to reevaluate document text 125 and output new parsed results 135 based on the invalid data structure fields 412.

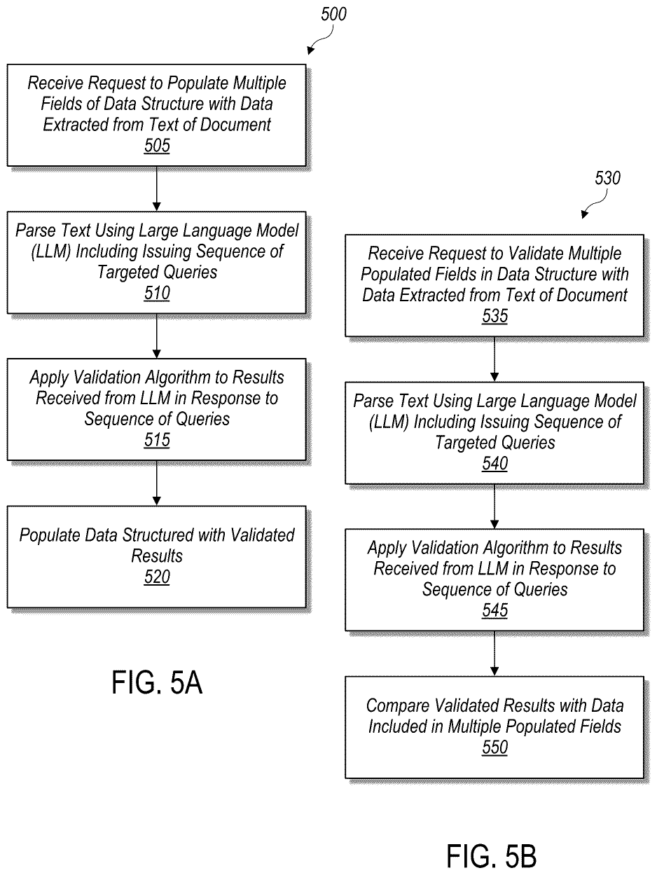

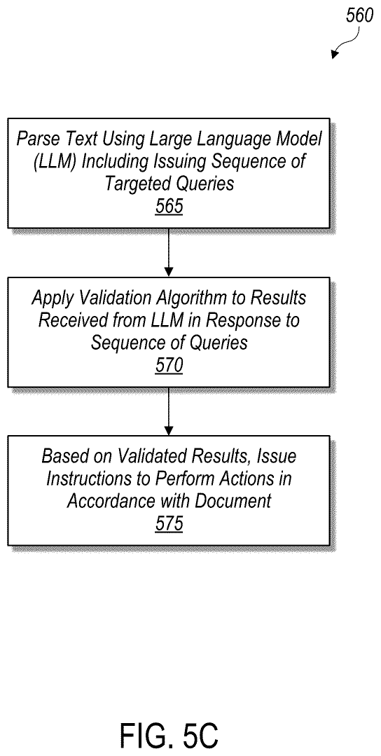

Turning now to FIG. 5A, a flow diagram of a method 500 is depicted. Method 500 is one embodiment of a method that may be performed by a computer system implementing the techniques described herein such as system 100. Method 500 may be performed by executing a set of program instructions stored on a non-transitory computer-readable medium.

At 505, the computer system receives a request to populate multiple fields (e.g., data structure field 412) of a data structure (e.g., table 410) with data (e.g., parsed results 135) extracted from text (e.g., document text 125) of a document (e.g., document 112). In various embodiments, the computer system performs an optical character recognition (OCR) (e.g., OCR module 120) on the document to determine the text. The OCR may identify text in one or more tables included in the document. The document may include a contract, and the multiple fields include a contract term of the contract. In various embodiments, the multiple fields include a rate associated with the contract.

At 510, the computer system parses the text using a large language model (LLM) (e.g., LLM 220). The parsing may include issuing, to the LLM, a sequence of queries (e.g., field queries 230) targeting individual ones of the multiple fields. In various embodiments, the parsing uses a plurality of parsing algorithms including a first algorithm (e.g., LLM algorithm 132) based on the LLM. The plurality of parsing algorithms may include a second algorithm (e.g., regex algorithm 210) based on regular expressions (e.g., regular expression 212) targeting individual ones (e.g., target field 214) of the multiple fields. The sequence of queries may include one or more queries (e.g., OCR queries 240) asking the LLM to correct errors in the text determined from the OCR.

At 515, the computer system applies a validation algorithm (e.g., validation module 140) to results received from the LLM in response to the sequence of queries. The validation algorithm may confirm a presence of results in the text of the document. In various embodiments, the computer system performs a word search (e.g., text search validation 310) of the text for ones of the results. The computer system may determine whether a consensus exists among the plurality of parsing algorithms. The computer system may issue a second sequence of queries (e.g., follow-up queries 340) asking the LLM to confirm the presence of results in the text of the document.

At 520, the computer system populates the data structured (e.g., populated data structure 145) with the validated results.

Turning now to FIG. 5B, a flow diagram of a method 530 is shown. Method 530 is another embodiment of a method performed by a computer system implementing the techniques described herein such as system 100. Method 530 may be performed by executing a set of program instructions stored on a non-transitory computer-readable medium.

Method 530 begins in step 535 with the computer system receiving a request to validate multiple populated fields in a data structure (e.g., an existing data structure 145) with data extracted from text (e.g., document text 125) of a document (e.g., document 112). In step 540, the computer system parses the text using a large language model (LLM), the parsing including issuing, to the LLM, a sequence of queries (e.g., field queries 230) targeting individual ones of the multiple fields (e.g., data structure fields 412). In step 545, the computer system applies a validation algorithm (e.g., one or more of algorithms 310-340) to results received from the LLM in response to the sequence of queries. In various embodiments, the validation algorithm confirms a presence of results in the text of the document. In some embodiments, applying the validating algorithm includes sending a sequence of follow-up queries (e.g., follow-up queries 340) asking the LLM to confirm the presence of results in the text of the document. In some embodiments, the parsing includes using a plurality of parsing algorithms, where using the LLM is one of the plurality of parsing algorithms. Applying the validation algorithm includes determining whether a consensus (e.g., quorum 320) exists among the plurality of parsing algorithms. In step 550, the computer system compares the validated results with data included in the multiple populated fields. In some embodiments, method 530 further includes altering data in one or more of the populated fields in the data structure in response to the data in the one or more populated fields not matching one or more of the validated results. In some embodiments, method 530 further includes, in response to the comparing including a mismatch, triggering a need to take a corrective action associated with the document.

Turning now to FIG. 5C, a flow diagram of a method 560 is shown. Method 560 is yet another embodiment of a method performed by a computer system implementing the techniques described herein such as system 100. Method 560 may be performed by executing a set of program instructions stored on a non-transitory computer-readable medium.

Method 560 begins, in step 565, with the computer system parsing text (e.g., text 125) of a document (e.g., document 112) using a large language model (LLM), the parsing including issuing, to the LLM, a sequence of queries targeting multiple fields associated with the document. In step 570, the computer system applies a validation algorithm (e.g., one or more of algorithms 310-340) to results received from the LLM in response to the sequence of queries. In various embodiments, the validation algorithm confirms a presence of results in the text of the document. In some embodiments, applying the validation algorithm includes searching (e.g., text search validation 310) the text for ones of the results. In some embodiments, applying the validating algorithm includes asking (e.g., follow-up queries 340) the LLM to confirm the presence of results in the text of the document. In step 575, the computer system issues, based on the validated results, one or more instructions to perform one or more actions (e.g., performed actions 155) in accordance with the document. In some embodiments, the one or more actions include modifying a data structure including multiple fields populated with data extracted from the text of the document.

### Exemplary Computer System

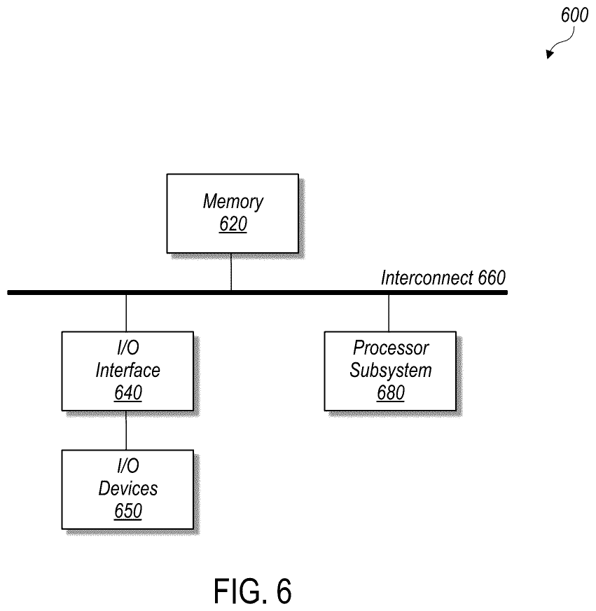

Turning now to FIG. 6, a block diagram of an exemplary computer system 600, which may implement system 100 (or one or more components included in system 100), is depicted. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Although a single computer system 600 is shown in FIG. 6 for convenience, system 600 may also be implemented as two or more computer systems operating together.

Processor subsystem 680 may include one or more processors or processing units. In various embodiments of computer system 600, multiple instances of processor subsystem 680 may be coupled to interconnect 660. In various embodiments, processor subsystem 680 (or each processor unit within 680) may contain a cache or other form of on-board memory.

System memory 620 is usable store program instructions executable by processor subsystem 680 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680. In some embodiments, program instructions that when executed implement elements of system 100 (e.g., elements 120-150) may be included/stored within system memory 620.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over Wi-Fi®, Bluetooth®, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,”“an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A non-transitory computer readable medium having program instructions stored therein that are executable by a computing system to perform operations comprising:
receiving a request to populate multiple fields of a data structure with data extracted from text of a document;
parsing the text using a large language model (LLM), wherein the parsing includes issuing, to the LLM, a sequence of queries targeting individual ones of the multiple fields;
applying a validation algorithm to results received from the LLM in response to the sequence of queries, wherein the validation algorithm confirms a presence of results in the text of the document; and
populating the data structured with the validated results.

2. The computer readable medium of claim 1, wherein applying the validation algorithm includes:
performing a word search of the text for ones of the results.

3. The computer readable medium of claim 1, wherein the parsing uses a plurality of parsing algorithms including a first algorithm based on the LLM.

4. The computer readable medium of claim 3, wherein the plurality of parsing algorithms includes a second algorithm based on regular expressions targeting individual ones of the multiple fields.

5. The computer readable medium of claim 3, wherein applying the validation algorithm includes:
determining whether a consensus exists among the plurality of parsing algorithms.

6. The computer readable medium of claim 1, wherein applying the validating algorithm includes:
issuing a second sequence of queries asking the LLM to confirm the presence of results in the text of the document.

7. The computer readable medium of claim 1, wherein the operations further comprising:
prior to parsing the text, performing an optical character recognition (OCR) on the document to determine the text.

8. The computer readable medium of claim 7, wherein the OCR identifies text in one or more tables included in the document.

9. The computer readable medium of claim 7, wherein the sequence of queries includes one or more queries asking the LLM to correct errors in the text determined from the OCR.

10. The computer readable medium of claim 1, wherein the document includes a contract; and
wherein the multiple fields include a contract term of the contract.

11. The computer readable medium of claim 1, wherein the document includes a contract; and
wherein the multiple fields include a number value associated with the contract.

12. A method, comprising:
receiving a request to validate multiple populated fields in a data structure with data extracted from text of a document;
parsing the text using a large language model (LLM), wherein the parsing includes issuing, to the LLM, a sequence of queries targeting individual ones of the multiple populated fields;
applying a validation algorithm to results received from the LLM in response to the sequence of queries, wherein the validation algorithm confirms a presence of results in the text of the document; and
comparing the validated results with data included in the multiple populated fields.

13. The method of claim 12, further comprising:
altering data in one or more of the populated fields in the data structure in response to the data in the one or more populated fields not matching one or more of the validated results.

14. The method of claim 12, further comprising:
in response to the comparing including a mismatch, triggering a need to take a corrective action associated with the document.

15. The method of claim 12, wherein applying the validating algorithm includes:
sending a sequence of follow-up queries asking the LLM to confirm the presence of results in the text of the document.

16. The method of claim 12, wherein the parsing includes using a plurality of parsing algorithms, wherein using the LLM is one of the plurality of parsing algorithms; and
wherein applying the validation algorithm includes determining whether a consensus exists among the plurality of parsing algorithms.

17. A non-transitory computer readable medium having program instructions stored therein that are executable by a device to perform operations comprising:
parsing text of a document using a large language model (LLM), wherein the parsing includes issuing, to the LLM, a sequence of queries targeting multiple fields associated with the document;
applying a validation algorithm to results received from the LLM in response to the sequence of queries, wherein the validation algorithm confirms a presence of results in the text of the document; and
based on the validated results, issuing one or more instructions to perform one or more actions in accordance with the document.

18. The computer readable medium of claim 17, wherein the one or more actions include modifying a data structure including multiple fields populated with data extracted from the text of the document.

19. The computer readable medium of claim 17, wherein applying the validation algorithm includes searching the text for ones of the results.

20. The computer readable medium of claim 17, wherein applying the validating algorithm includes asking the LLM to confirm the presence of results in the text of the document.
